(19) United States
(12) Patent Application Publication
(10) Pub. No.: US 2002/0111796 A1
(43) Pub. Date: Aug. 15, 2002

(54) Voice processing method, telephone using the same and relay station

(76) Inventor: Yasushi Nemoto, Naka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/796,814

(22) Filed: Feb. 28, 2001

(30) Foreign Application Priority Data
Feb. 13, 2001 (JP) 2001-035947

(51) Int. Cl. G10L 19/14

(52) U.S. Cl. 704/205

(57) ABSTRACT

There is provided a voice processing technology and device utilizing the voice processing technology, capable of making the voice on the telephone receiver easy to hear according to the frequency. This invention utilizes a frequency conversion means capable of converting the input voice frequency to a desired frequency. The frequency conversion level or frequency shift can be optionally set for each frequency. The frequency is not changed if the input voice frequency is low. The higher the voice frequency, the greater the frequency conversion shift to a low frequency range for an easy to hear voice.

### BACKGROUND OF THE INVENTION

1. Field of the Invention

The present invention relates to a voice processing method, telephone using the voice processing method and relay station for converting the audio frequency of the telephone receiver to a low audio frequency range to make the voice easy to be heard.

2. Description of Related Art

Along with the increasing number of elderly people in our society, the incidence of hearing problems due to advanced age or the so-called hard-of-hearing elderly are predicted to increase greatly. Poor hearing due to aging may often result in weak hearing with respect to certain frequencies, especially at high frequency sounds. This disability may make it difficult to hear the voice of the calling party over the telephone.

Conventional methods for assisting the elderly having difficulty in hearing include methods such as raising the volume of the voice on the telephone receiver or raising the sound level at high frequency, where elderly people have difficulty in hearing, to augment their characteristics. However, these methods have the problem, especially in case of cellular phones, that the speech of a calling party can be overheard in the surrounding area due to the large volume. Another problem is that the large volume of the voices on the telephone receiver often exceeds its dynamic range resulting in distortion of sound or voice from the receiver, which deteriorates quality of speech received.

In order to solve the problems, a telephone disclosed in Japanese Patent Laid-Open No. 10-70425 comprises an audio frequency converter between a receive circuit and a telephone receiver (handset) so as to convert the audio frequency of the telephone receiver.

In this related art, speech signal from the calling party is converted into an audio signal having a suitable frequency for the telephone user to hear, when a noise level deriving from circumstance of the calling party is larger than predetermined value. This conversion is not taken place when the noise level is lower than the predetermined value. This audio signal is reproduced from the receiver.

However this related art has a problem that the conversion does not work when the telephone is used in a quiet circumstance. In addition, the audio frequency converter converts the calling party's voice in a fixed frequency, which makes the user feel difficult to identify the calling party from his/her voice. Further, unnecessary conversion of audio signals in low frequency ranges is performed.

It is an object of to solve the problems of the related art and to provide a telephone apparatus using a voice processing technology and device to change the audio frequency of the signal received according to its frequencies whereby improving the quality of speech received.

### SUMMARY OF THE INVENTION

To effectively resolve the problem, the invention utilizes a voice processing method comprising the steps of detecting a plurality of predetermined audio frequencies for telephone receiver, and performing frequency conversion of the respective frequencies according to a conversion level established according to the detected frequencies.

To effectively resolve the problem, a telephone apparatus of this invention includes a frequency detector to detect a frequency of audio signal of telephone receiver, a frequency converter to convert the frequency detected by the frequency detector, and a control section to control the frequency detector and the frequency converter, wherein said frequency converter performs frequency conversion of the respective frequencies according to a conversion level established according to the respective detected frequencies.

### BRIEF DESCRIPTION OF THE DRAWINGS

FIG. 1A to FIG. 1C are drawings showing the interrelation of frequency conversion input/output signals and the conversion scale characteristics for voice frequencies in a voice processing method of an embodiment of the invention. FIG. 1A shows a conversion rate to the frequency of the audio input signal. FIG. 1B shows a spectrum of the input signal before inputted to the frequency converter. FIG. 1C shows a spectrum of the signal outputted from the frequency converter.

FIG. 2A to FIG. 2E are drawings showing patterns of the interrelation of frequency conversion input/output signals and the conversion scale characteristics for voice frequencies in the voice processing method of the embodiment of the invention. FIG. 2A shows a conversion rate to the frequency of the audio input signal. FIG. 2B shows a spectrum of the input signal before inputted to the frequency converter. FIG. 2C shows a spectrum of the signal outputted from the frequency converter using conversion pattern 1. FIG. 2D shows a spectrum of the signal outputted from the frequency converter using conversion pattern 2. FIG. 2E shows a spectrum of the signal outputted from the frequency converter using conversion pattern 3.

FIG. 3 is a perspective view showing an embodiment of an external view of a cellular phone of the invention.

FIG. 4 is a block diagram showing an embodiment of the cellular phone of the invention.

FIG. 5 is a front view showing an embodiment of a screen displayed on a display section.

FIG. 6 is a drawing showing a structure of a frequency conversion system utilizing the cellular phone in a first embodiment of the invention.

FIG. 7 is a flow chart showing the service of the frequency conversion system utilizing the cellular phone in the first embodiment of the invention.

### DETAILED DESCRIPTION OF THE PREFERRED EMBODIMENTS

The preferred embodiments of the invention are hereinafter described while referring to the accompanying drawings.

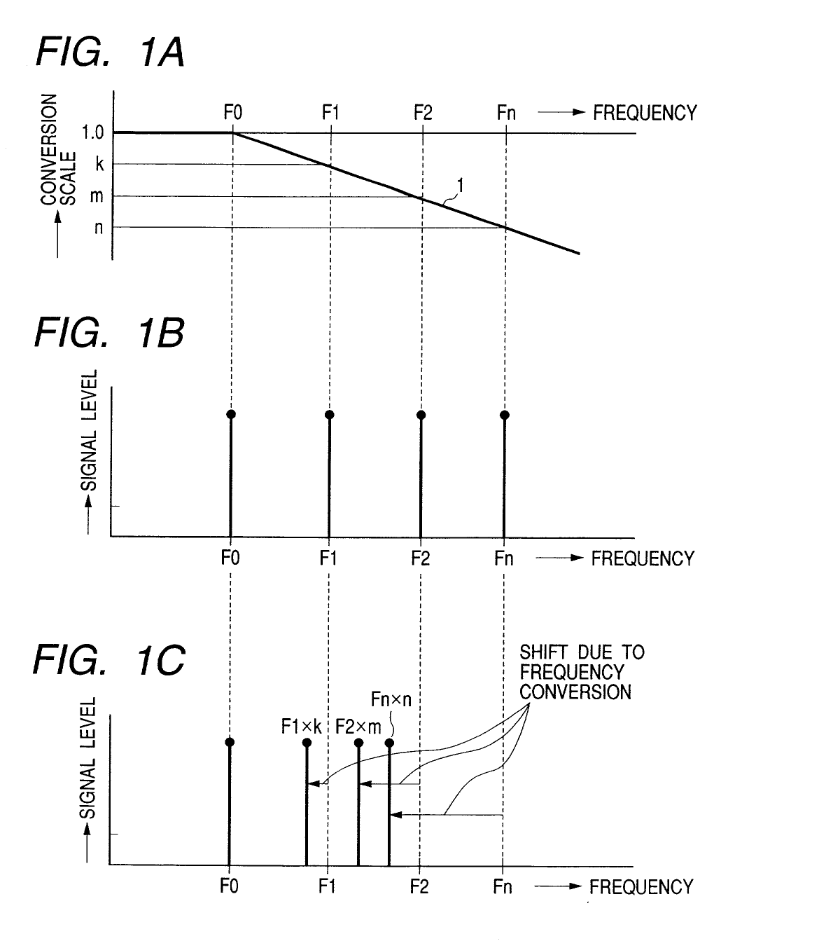

The same reference numerals in FIG. 1 through FIG. 5 in this embodiment indicate the same item or a similar item.

Hereinafter, an embodiment of input voice frequency conversion method, as a voice processing method suitable for elderly person will be explained referring to FIG. 1.

FIG. 1A to FIG. 1C show characteristic charts of audio frequency vs conversion rate or conversion scale. FIG. 1A shows a conversion rate to the frequency of the audio input signal. Horizontal axis indicates the frequency and vertical axis indicates the conversion rate. Line 1 indicates a conversion characteristic of the frequency converter 108. Up to the frequency F0, the conversion rate is 1.0, and conversion rate decreases contrary to the increase in frequency. For instance, at frequencies F1, F2, and Fn, (where, F0>F1>F2>, . . . >Fn) conversion rates corresponding to the frequencies are k, m, and n, respectively, where each of k, m, n indicates a positive value smaller than 1.0, and the relationship between k, m, n is 1.0>k>m>n>0. FIG. 1B shows a spectrum of the input signal before inputted to the frequency converter 108. Here, vertical axis indicates a signal level, and spectrum at frequencies F0, F1, F2 and Fn are depicted. FIG. 1C shows a spectrum of the signal outputted from the frequency converter 108. According to the conversion rate, frequency F1 is converted to frequency F1×k (k times F1), frequency F2 is converted to frequency F2×m (m times F2), frequency Fn is converted to frequency Fn×n (n times Fn), whereas frequency F0 remains as it is since conversion rate is 1.0.

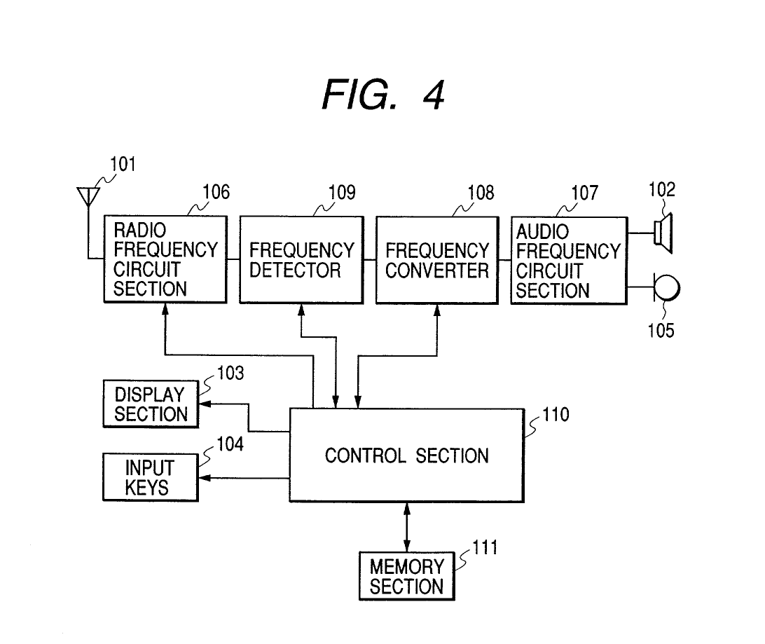

As shown in FIGS. 1A through 1C, the higher the input signal frequency becomes, the larger the shift in frequency becomes. The conversion rate is set for each the frequencies, and stored in the memory section 111 (see FIG. 4). The conversion rate here is the rate or multiplier for performing frequency conversion of the input signal frequency, and the smaller the value of the multiplier is, the larger the conversion level (shift) from the input signal frequency becomes. Since these are audio signals, it is desirable to use “Hz” as their unit for low range frequencies and “kHz” for high range (higher than 1 kHz) frequencies.

In the conversion, the frequency F0 signal is a low frequency sound that is easily heard by the listener so that frequency conversion is not required.

The frequency F1 signal may be somewhat hard to hear for users with slightly deteriorated hearing so the frequency may be converted (shifted) slightly to the low frequency side to make it easier to hear.

The frequency F2 signal is a high frequency sound hard to hear for users with deteriorated hearing, so that the frequency must be greatly converted (shifted) to the low audio frequency side to make it easier to hear and the conversion rate m becomes a value smaller than the conversion rate k.

The frequency Fn signal is a high frequency sound extremely hard to hear for users with deteriorated hearing, so that the frequency must be greatly converted (shifted) to the low audio frequency side to make it easier to hear and the conversion rate n becomes a value much smaller than the conversion rate m.

Above mentioned frequency shift can be performed in an ideal manner when the telephone receiver audio signal is digitally converted.

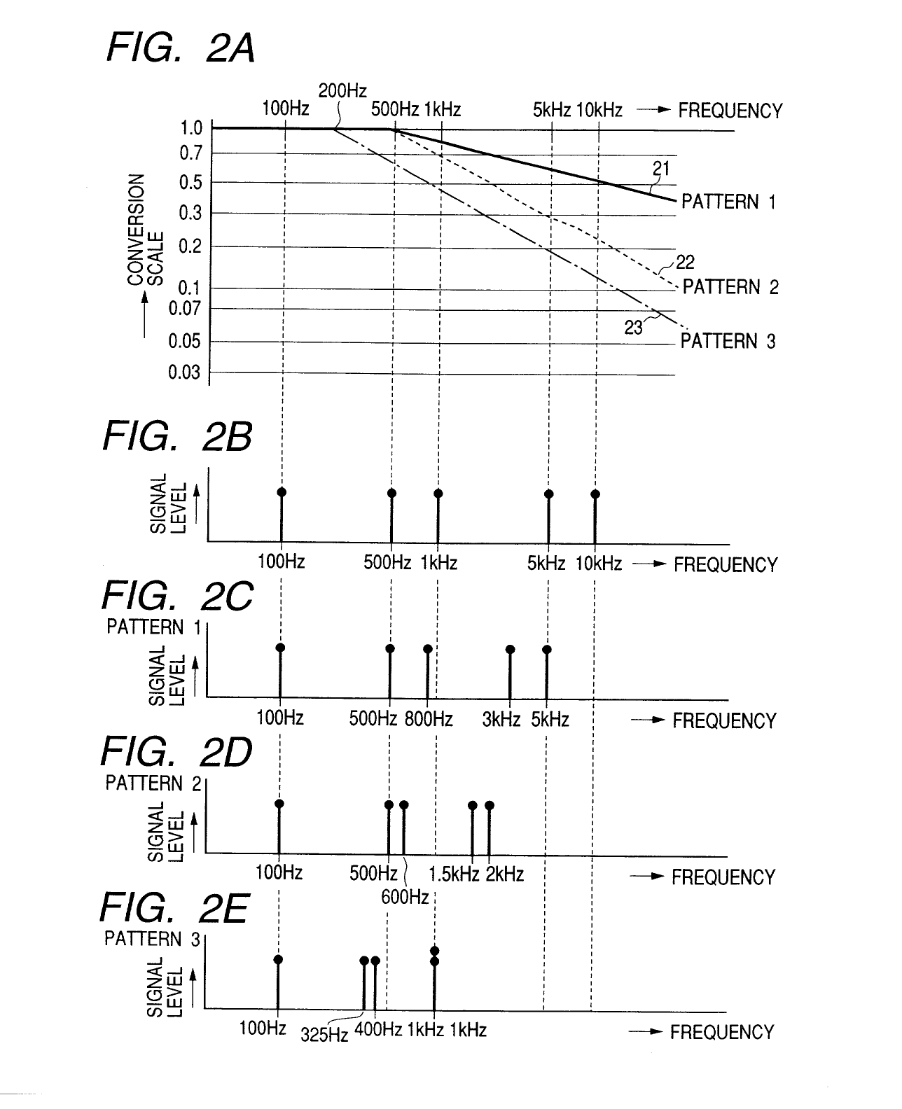

Specific examples of a combination pattern of frequency conversion rate for each of the input signal frequencies shown in FIG. 1A are next described using FIG. 2A, FIG. 2B and FIG. 2C.

FIG. 2 shows practical example of frequency conversion, with some patterns of characteristic curves. FIG. 2A shows a conversion rate to the frequency of the audio input signal. In FIG. 2A, three (3) patterns of characteristic curves, Pattern 1, Pattern 2, Pattern 3 are depicted. The frequency is shown on the horizontal axis and the conversion level (shift) is shown on the vertical axis.

FIG. 2B shows a spectrum of the input signal before inputted to the frequency converter 108. Here, vertical axis indicates a signal level, and spectrum at frequencies 100 Hz, 500 Hz, 1 kHz, 5 kHz, and 10 kHz are depicted. FIG. 2C shows a spectrum of the signal outputted from the frequency converter 108 using conversion pattern 1. According to conversion rate of Pattern 1, the signal is converted into the one having spectrum at frequencies 100 Hz, 500 Hz, 800 Hz, 3 kHz, and 5 kHz.

FIG. 2D shows a spectrum of the signal outputted from the frequency converter 108 using conversion pattern 2. According to conversion rate of Pattern 2, the signal is converted into the one having spectrum at frequencies 100 Hz, 500 Hz, 600 Hz, 1.5 kHz, and 2 kHz.

FIG. 2E shows a spectrum of the signal outputted from the frequency converter 108 using conversion pattern 3. According to conversion rate of Pattern 3, the signal is converted into the one having spectrum at frequencies 100 Hz, 325 Hz, 400 Hz, 1 kHz (0.2 times 5 kHz), and 1 kHz (0.1 times 10 kHz).

In this embodiment, the frequency characteristic curves 21, 22, 23 corresponding to pattern 1, pattern 2, pattern 3, respectively are stored and set in the memory section 111 (see FIG. 4).

Pattern 1 or characteristic curve 21 is for the case when the deterioration in hearing characteristics is comparatively small. A slight conversion (shift) of the frequency to the low audio frequency side is sufficient so that as shown in FIG. 2A, the conversion scale is 1.0 up to a signal frequency of 500 Hz; and the conversion scale becomes smaller as the audio increases above 500 Hz. At 1 kHz the conversion scale becomes 0.8 and at 5 kHz the conversion scale becomes 0.6 and at 10 kHz the conversion scale becomes 0.5 so that the frequency conversion level (shift) is set smaller. As a result as shown in FIG. 2C, voice signal from the calling party having frequency of 1 kHz is converted into 800 Hz, Similarly, 5 kHz input signal is shifted to 3 kHz, 10 kHz input signal is shifted to 5 kHz to make the audio signal easier to be heard.

Pattern 2 or characteristic curve 22 is for the case when the deterioration in hearing characteristics is comparatively serious. In pattern 2, the conversion scale is 1.0 up to a signal frequency of 500 Hz, and the conversion scale becomes smaller as the frequency increases above 500 Hz.

At 1 kHz the conversion scale becomes 0.6, at 5 kHz 0.3 and at 10 kHz 0.2 so that the frequency conversion level (shift) is set larger. As shown in FIG. 2D, input frequency of 1 kHz is shifted to 600 Hz , 5 kHz to 1.5 kHz, and 10 kHz to 2 kHz.

Pattern 3 or characteristic curve 23 is for the case when the deterioration in hearing characteristics is very serious. In this case, a frequency that is easy to hear inclines more to the low audio frequency side. The characteristic of the frequency conversion scale shown in FIG. 2A is 1.0 up to a signal frequency of 300 Hz, and the frequency conversion scale becomes smaller as the audio becomes higher than 300 Hz. At 500 Hz, the conversion scale is 0.65 and at 1 kHz the conversion scale is 0.4, at 5 kHz the conversion scale is 0.2, at 10 kHz the conversion scale is 0.1, so that the frequency conversion level (shift) is set even larger. As shown in FIG. 2E, voice frequency of 1 kHz is shifted to 400 Hz, 5 kHz to 1 kHz, and 10 kHz incidentally to 1 kHz.

Three combination patterns are shown in the above example however many more combination patterns may be utilized.

Needless to say, the conversion scale and conversion level for each frequency do not have to be fixed to the values in the above examples.

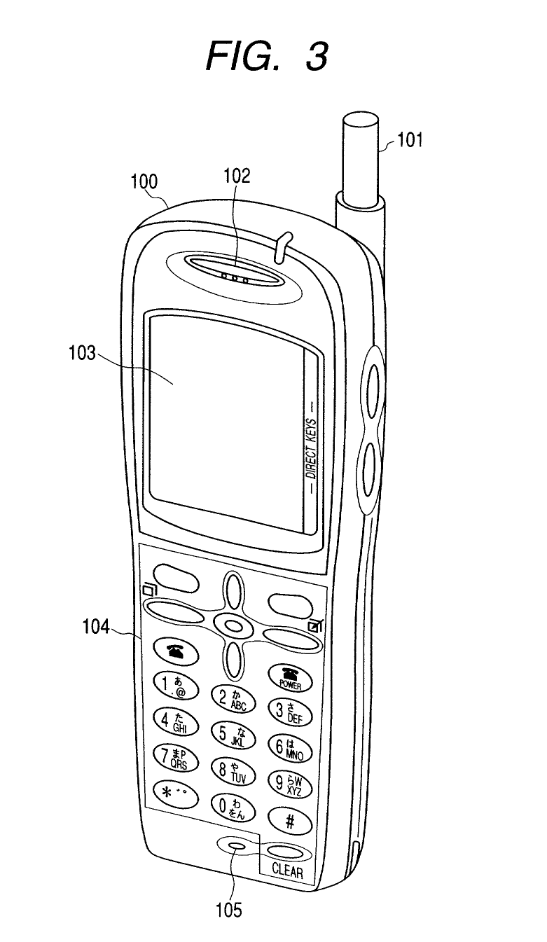

An embodiment applicable to cellular phones using the voice processing method of this invention is described while referring to FIG. 3 and FIG. 4.

FIG. 3 is a perspective view showing an embodiment of an external view of the cellular phone of the invention. In the figure, the reference numeral 101 denotes a transmit/receive antenna, 102 is a phone receiver, 103 is a display section showing the various information, 104 denotes input keys for entering information including number keys used when making settings and entering telephone numbers, and 105 is a transmit section.

FIG. 4 shows a block diagram of the cellular phone in this embodiment. In the figure, the reference numeral 106 denotes a radio frequency circuit section containing transmit and receive functions and this radio frequency circuit section outputs audio frequency signal to frequency detector 109, 107 is a audio frequency circuit section for generating a voice signal for telephone receiver, 108 is a frequency converter for converting the frequency of the telephone receiver voice, 109 is a frequency detector for analysis/detection of the telephone receiver voice frequency, 110 is a control section 110 for controlling the cellular phone, 111 is a memory section for storing the various information. Audio frequency circuit section 107, frequency converter 108, frequency detector 109 handles audio frequency signals.

The procedure for setting the frequency conversion mode is explained referring to FIGS. 3 and 4. The control section 110 controls the display section 103 so as to display a query thereon to ask the user whether to use frequency conversion mode when the input keys 104 are operated in a predetermined manner. When the user makes an affirmative response to the query by operation of the input key 104, the control section 110 sets the frequency conversion mode. When the user selects predetermined set of conversion rates for predetermined frequencies, or predetermined pattern of frequency conversion (in most cases, which is set as default), the control section 110 finishes the setting operation and store the selected frequency conversion mode in the memory section 111. Thereafter, when the cellular phone receives a call, the control section 110 starts the predetermined frequency conversion mode and starts processing.

When the user wants to set an original frequency conversion pattern, that is suitable for him/her, the user selects his/her favorite pattern among the ones stored in the memory section 111 beforehand, by operating the input keys 104 following the guidance on the display section 103, and by reproducing the voice data stored in the memory section 111. When this operation is finished, the settings are now complete.

In the above explanation, voice data stored in the memory section 111 is used during setting of the conversion level patterns or conversion scale for each frequency, however settings may also be made according to the voice during the telephone call.

The voice data stored in the memory section 111 may also be comprised of data added later by the manufacturer or the user.

The plurality of conversion scale or conversion level patterns set beforehand for each frequency may also be a conversion rate or conversion level pattern added afterwards by the manufacturer or by the user.

The call receive operation when this cellular phone is in frequency conversion mode is next explained. The audio data is extracted by the radio frequency circuit section 106 from a receive signal input from the transmit/receive antenna 101 and output to the audio frequency circuit section 107 by way of the frequency detector 109 and the frequency converter 108. In the audio frequency circuit section 107, the phone receiver voice is generated from the voice data and output to the phone receiver 102. The frequencies currently being handled are detected by the frequency detector 109 from the voice signal output from the radio frequency circuit section 106, and the frequency information is reported to the control section 110. The control section 110 procures frequency conversion level (shift) information from the memory section 111, by means of frequency information from the frequency detector 109, and controls the frequency conversion level (amount of shift) of the frequency converter 108. The voice signal whose frequency is shifted in this way is reproduced in the audio frequency circuit section 107, sent to the phone receiver 102 and reproduced as voice. In this embodiment, the frequency converter 108 converts the audio signal supplied to the audio frequency circuit section 107 according to the predetermined pattern. The audio frequency circuit section 107 supplies the voice signal converted by the designated pattern to the phone receiver 102 so that the user can hear the voice of the calling party without difficulty. In this figure, the reference numeral 105 indicates a microphone.

In this embodiment, no frequency conversion is performed when not set to the frequency conversion mode, and the frequency signal sent to the phone receiver 102 is reproduced as audio.

In FIG. 4, the frequency converter 108 and the frequency detector 109 are listed as separate blocks however processing may also be performed in the audio frequency circuit section 107, and the frequency converter 108 and the frequency detector 109 may comprise one block.

When in frequency conversion mode at the start of a phone conversation, the calling party may be notified that frequency conversion mode has been enabled, by means of communication data by way of the control section 110, the radio frequency circuit section 106 and the antenna 101.

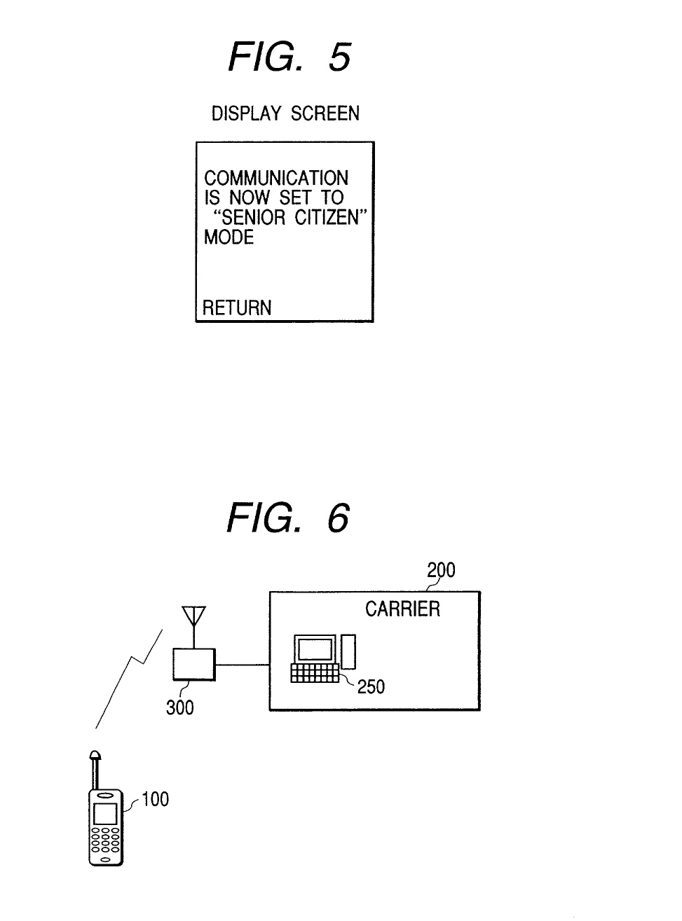

When the calling party has been notified by means of communication data that frequency conversion mode has been enabled for telephone receiver voice frequencies, an example of the display on the cellular phone of the calling party is shown in FIG. 5. FIG. 5 is a frontal view showing an embodiment of the screen displayed on the display section.

The message, “Communication is now set to ‘Senior Citizen’ mode” appears on the display of the cellular phone to show from the procured communication data, the information that frequency conversion mode has been enabled.

This embodiment was described using a cellular phone as an example, however this invention is not limited to cellular phones and is applicable to all telephones for example, cordless telephones, and PHS, ISDN, telephone lines, etc.

This embodiment was described utilizing a cellular phone incorporating voice processing technology however a frequency may also be shifted and sent to users by a relay station in cases where users have registered a pre-stored shift for telephone receive voice frequencies by utilizing relay stations such as base stations and switching boards utilizing this voice processing technology. A frequency detector, frequency converter, a memory section to store the plurality of conversion levels combinations for each telephone receiver voice frequency and a control section to control these conversion levels are therefore installed in the relay station and by controlling the memory section with the control section, a function to hold the status (mode) for converting the frequency of the telephone receiver voice store in the memory section, a function to select a conversion level from a plurality of conversion levels for each telephone receiver voice frequency stored in the memory section, a function to notify the calling party that a status (mode) for frequency conversion of telephone receiver voice frequencies is being used, and a function to select the conversion level for each frequency according to a voice reproduced by the voice information stored in the memory section can be provided.

In this invention as described above, the voice on the telephone receiver is made easy to hear since high telephone receiver voices requiring supplementing of audio characteristics can be converted to low voices, and low telephone receiver voices not requiring supplement of audio characteristics are left unchanged so that the calling party can be identified by voice.

In the telephone of this invention, there is no need to set the frequency conversion level and the telephone receiver frequency conversion mode each time a telephone call is made. Operability is also improved since the frequency conversion level for each telephone receiver voice frequency can be selected from a plurality of patterns.

The other party is notified of the frequency conversion mode for telephone receiver voice frequencies and a display is shown on the cellular phone of the other party so that the calling party is made aware that the response may contain unnatural delays in the speech.

The operating convenience is improved since patterns can be selected by reproducing voices from stored voice information except for voices received during telephone calls.

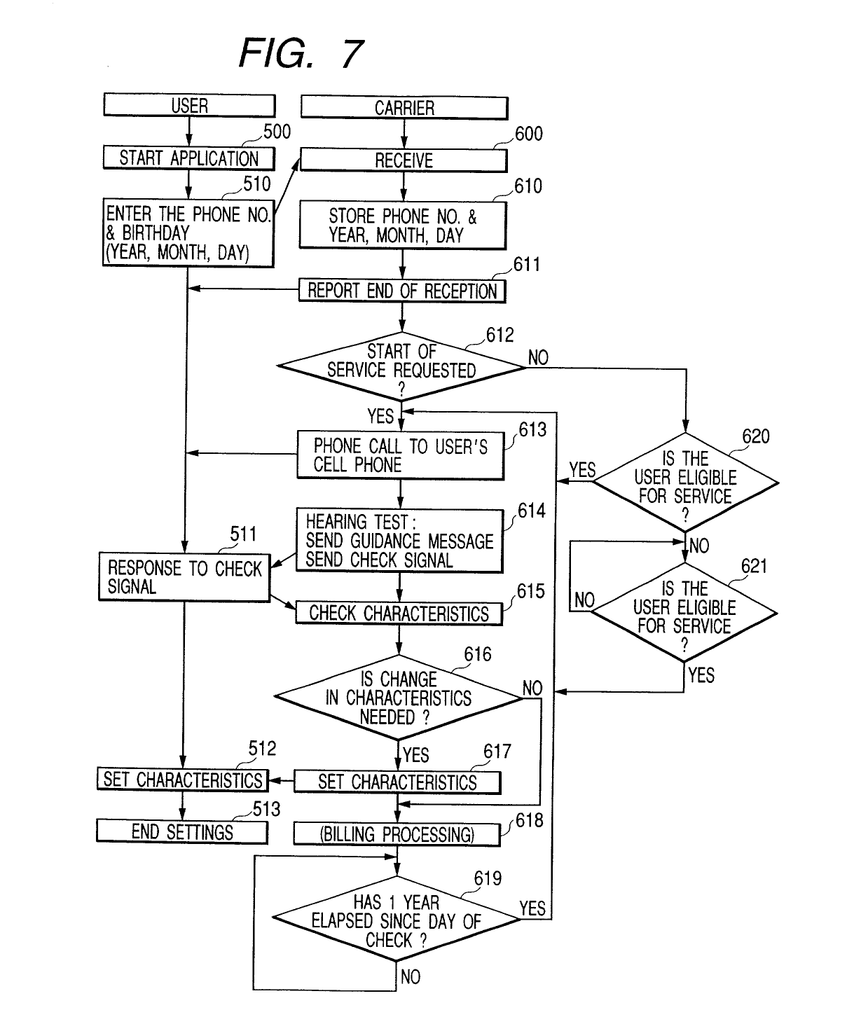

A business model of the frequency shift service for the user is described while referring to the examples in FIG. 6 and FIG. 7. The business model utilizes a cellular phone 100 used in the embodiments. First of all, as shown in FIG. 7, the user (subscriber) applies for current or future use of this service to the communications carrier for the cellular phone 100 currently possessed by the user (step 500). The application is made by a telephone call via a base station 300 from the cellular phone or by the Internet or electronic mail. Application for the service may also be made simultaneously along with the contract when purchasing the cellular phone or when changing models. When making application, the user contacts a carrier 200 gives his own telephone number and birth date (step 510). In this embodiment, the carrier 200 starts this service when the user becomes 60 years old. The carrier 200 receives the application (step 600). Along with storing this data in a host computer 250 (step 610) and reporting the end of reception to the user (step 611), the host computer 250 judges if the user has not yet reached the age of 60 (step 620) unless the user files a request to start the service even if he is younger than 60 (step 612-no). The carrier 200 places a hold on issue of the service at steps 620 and 621 until the user making the application has reached the age of 60 as calculated from the birth date, upon which the service is commenced. If the user has already reached 60 at the time the application is made or wants to receive the service even if not yet 60 years of age, then the service is commenced after accepting the application (step 612-yes).

Deterioration in hearing varies according to the individual so prior to starting service, the carrier 200 makes a phone call (step 613) and sends a signal for testing hearing to the cellular phone 100 (step 614) in order to determine the required frequency conversion scale pattern. In this testing for example, after sending a message about the testing method, the audio frequency signal level is gradually raised with 100 Hz, 500 Hz, 1 kHz, 5 kHz and 10 kHz signals during transmission to the user. The user presses a pre-established key upon starting to hear that sound (step 511). The user's hearing characteristics can in this way be determined (step 615) when the cellular phone 100 is used and can be stored in the host computer 250. Next, the host computer 250 sets a pattern matching the user's hearing characteristics in the cellular phone 100 of the user (step 617). This pattern is then stored in the user's cellular phone 100 (step 512) and after the setting is over (step 513), frequency conversion of telephone receiver voices is performed with the stored pattern for subsequent telephone calls. When various types of patterns have been preset in the cellular phone 100, the host computer 250 may compare these patterns with the user's hearing characteristics and select the ideal pattern from among the various patterns. This hearing test may also be performed for both ears and in such a case, the respective patterns for the right ear characteristics and the left ear characteristics are sent to the cellular phone 100 from the host computer 250. The cellular phone 100 may store the respective patterns for the right ear characteristics and the left ear characteristics and allow any of the patterns to be selected by the user. In such a case, the cursor rightward and leftward movement keys may be utilized. The right and the left can in this way be selected naturally.

In telephones communicating over an actual telephone line, in many cases a plurality of people may use one telephone unit but in the case of a cellular phone, use is almost always limited to one person. Frequency characteristics can be set to match the user with no problem.

The hearing test may be performed periodically (once a year or once every 6 months) (step 619-yes), instead of just at the commencement of service, and the patterns may then be updated at step 616. If the user wishes, the patterns may also be updated at that time.

This service may be provided at no charge. In such a case, the carrier's reputation improves and subscribers to the carrier are likely to increase, so that greater income can be obtained from contract fees and telephone call charges.

When billing for this service (step 618), a low user fee of approximately 100 yen a month may be charged and added to the telephone call charges. Further, if the user is an elderly person or suffers from some kind of hearing disability, then no usage feed need be charged and the user only billed for the hearing test. The hearing test may be free of charge the first time administered and a fee of a few hundred yen then charged to the user from the second hearing test onward and this fee may be added to the telephone call charges. In this case, when determined during the hearing test that the frequency conversion service is necessary, a discount for telephone call charges may also be set. In this case also, the carrier can expect increased revenues from an increase in subscribers due to the improved reputation of the carrier. However, no frequency conversion service or discounts would be granted when determined in the hearing test that the user's hearing is normal.

Making this service available is also likely to spread the use of cellular phones among the elderly.

Therefore as described above, high frequency telephone receiver voices requiring supplementing of audio characteristics can be converted to low frequency telephone receiver voice range to obtain an easy to hear voice.

The present invention is not restricted to a telephone apparatus or a cellular phone. The present invention can also be applied to a relay station. In this case, a frequency detector for detecting the phone receiver voice frequency at the output of the radio frequency circuit which corresponds to frequency detector 109, a frequency converter to convert the frequency detected by the frequency detector which corresponds to frequency converter 108, and a control section to control the frequency detector and the frequency converter which corresponds to control section 110, are disposed within a relay station. The frequency converter also performs frequency conversion of the detected frequencies according to a conversion rate established according to the respective frequency in the same way as the above embodiment.

What is claimed is:

1. A voice processing method comprising the steps of:
a step for detecting a plurality of predetermined audio frequencies for telephone receiver; and
a step for performing frequency conversion of the respective frequencies according to a conversion rate established according to the detected frequencies.

2. A voice processing method according to claim 1, wherein the higher the input audio frequency for conversion to a low audio frequency, the larger the frequency conversion rate becomes.

3. A telephone apparatus comprising:
a frequency detector to detect a frequency of audio signal of telephone receiver;
a frequency converter to convert the frequency detected by the frequency detector; and
a control section to control the frequency detector and the frequency converter,
wherein said frequency converter performs frequency conversion of the respective frequencies according to a conversion level established according to the respective detected frequencies.

4. A telephone apparatus comprising:
a frequency detector to detect a frequency of audio signal of telephone receiver;
a frequency converter to convert the frequency detected by the frequency detector; and
a control section to control the frequency detector and the frequency converter; and
a memory section for storing plural pieces of information defining plural combinations of received telephone receiver voice frequencies and their conversion rates,
wherein one combination is selected from information defining plural combinations of conversion levels for each telephone receiver voice frequency, and the frequency converter performs frequency conversion of the detected respective frequencies according to the selected frequency conversion rate combination.

5. A relay station comprising:
a frequency detector for detecting the phone receiver voice frequency at the output of the radio frequency circuit;
a frequency converter to convert the frequency detected by the frequency detector; and
a control section to control the frequency detector and the frequency converter,
wherein the frequency converter performs frequency conversion of the detected frequencies according to a conversion rate established according to the respective frequency.

6. A frequency conversion method comprising the steps of:
transmitting a plurality of frequency signals to a cellular phone;
receiving a response to said frequency signals;
determining the response characteristics of the frequencies to the received response data;
setting frequency conversion characteristics;
sending said frequency conversion characteristics to said cellular phone; and
changing the frequency characteristics during reception in the cellular phone.
